(19) United States
(12) Patent Application Publication
(10) Pub. No.: US 2005/0023876 A1
(43) Pub. Date: Feb. 3, 2005

(54) Folding chair

(76) Inventor: William C. Savage, Gastonia, NC (US)

Correspondence Address: Schwartz Law Firm, P.C., SouthPark Towers, Suite 530, 6100 Fairview Road, Charlotte, NC, 28210, US

(21) Appl. No.: 10/633,144

(22) Filed: Jul. 31, 2003

(51) Int. Cl. B60N 2/02

(52) U.S. Cl. 297/378.1

(57) ABSTRACT

A folding chair includes a seat defining a top sitting area adapted for supporting a user in a sitting position. A back extends outwardly from the seat in an open chair position, and defines a back support area for engaging a back of the user. A hinge pivotably connects the seat and the back whereby at least one of the seat and back is moveable from the open chair position to a closed chair position. In the closed chair position, the back support and sitting areas reside in overlying relation within a common perimeter. The common perimeter is secured against entry of outside elements such that the back support and sitting areas remain clean when the chair is returned to the open chair position.

### TECHNICAL FIELD AND BACKGROUND OF THE INVENTION

This invention relates to a folding chair. The present chair is pivotable between open and closed positions, and includes features which in the closed position maintain the sitting areas clean and dry for immediate use when unfolded. The invention is especially applicable for outdoor uses, such as playground seating, stadium seating, boat chairs, beach chairs, and lawn, patio and deck furniture. The invention eliminates the need for special chair covers and dry storage of the chair when not in use.

### SUMMARY OF INVENTION

Therefore, it is an object of the invention to provide a folding chair which effectively secures a common perimeter of the seat and back when folded to prevent the entry of water, dirt, sand, and other outside elements.

It is another object of the invention to provide a folding chair which is especially applicable for outdoor use.

It is another object of the invention to provide a folding chair which is immediately useable when unfolded to the open position without the need to first clean the back support and sitting areas.

It is another object of the invention to provide a folding chair which is conveniently folded and unfolded.

It is another object of the invention to provide a folding chair which may be designed for convenient stacking and transport.

It is another object of the invention to provide a folding chair which may include accessory features, such as cup holders, arm supports, detachable food trays, and the like.

It is another object of the invention to provide a folding chair which may be constructed in an infinite number of shapes and designs applicable for any desired indoor or outdoor use.

These and other objects of the present invention are achieved in the preferred embodiments disclosed below by providing a folding chair including a seat defining a top sitting area adapted for supporting a user in a sitting position. A back extends outwardly from the seat in an open chair position, and defines a back support area for engaging a back of the user. Means are provided for pivotably connecting the seat and the back whereby at least one of the seat and back is moveable from the open chair position to a closed chair position. In the closed chair position, the back support and sitting areas reside in overlying relation within a common perimeter. Means are provided for securing the common perimeter against entry of outside elements such that the back support and sitting areas remain clean when the chair is returned to the open chair position.

The term “connecting” is defined broadly herein to mean any structural arrangement of the seat and back in a manner enabling pivoting movement of one of the seat and back to engage the other of the seat and back in the closed chair position. No direct mechanical linkage is required between the seat and back.

The term “common perimeter” refers to substantially corresponding boundaries of overlying surface areas defined by the seat and back in the closed chair position.

The term “outside elements” refers to any element, such as water, sand, dirt, food, and beverage.

According to another preferred embodiment of the invention, the means for connecting the seat and back includes a hinge.

The term “hinge” is used broadly herein to mean any structure capable of pivotably connecting the seat and back of the chair together.

According to another preferred embodiment of the invention, the means for securing the common perimeter includes a rim formed with one of the seat and back, and adapted to fit closely adjacent an edge of the other of the seat and back.

According to another preferred embodiment of the invention, the seat defines a recess adapted for receiving a seat cushion in the top sitting area.

According to another preferred embodiment of the invention, the back defines a recess adapted for receiving a back cushion in the back support area.

According to another preferred embodiment of the invention, the means for securing the common perimeter includes an annular rim extending around the recess formed with one of the seat and back, and adapted to fit closely adjacent an annular mouth of the recess formed with the other of the seat and back.

According to another preferred embodiment of the invention, one of the annular rim and mouth includes a locking rib and the other of the annular rim and mouth includes a complementary groove. The rib and groove cooperate to snap attach the back and seat together with the chair in the closed chair position.

According to another preferred embodiment of the invention, the means for securing the common perimeter includes a rim formed with one of the seat and back, and a complementary perimeter channel formed with the other of the seat and back and adapted for receiving the rim.

According to another preferred embodiment of the invention, the back includes a cushion located in the back support area.

According to another preferred embodiment of the invention, the seat includes a cushion located in the sitting area.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a perspective view of a folding chair according to one preferred embodiment of the present invention and showing the chair in a closed position;

FIG. 2 is a perspective view of the folding chair illustrating the hinge connection of the seat and back;

FIG. 3 is a perspective view of the folding chair with the back lifted away from the seat in an open chair position;

FIG. 4 is a plan view of the chair back showing the back support area;

FIG. 5 is a plan view of the seat showing the top sitting area;

FIG. 6 is a side elevation of the chair with the back removed and spaced-apart from the seat;

FIG. 7 is a side elevation of the chair with the seat and back assembled in the closed chair position;

FIG. 8 is a cross-sectional view of the chair taken substantially along line 8-8 of FIG. 7;

FIG. 8A is an enlarged view of the blow-out area indicated in FIG. 8;

FIG. 9 is a cross-sectional view of the chair according to a further embodiment of the present invention;

FIG. 9A is an enlarged view of the blow-out area indicated in FIG. 9;

FIG. 10 is a cross-sectional view of the chair according to a yet another embodiment of the present invention; and

FIG. 10A is an enlarged view of the blow-out area indicated in FIG. 10.

### DESCRIPTION OF THE PREFERRED EMBODIMENT AND BEST MODE

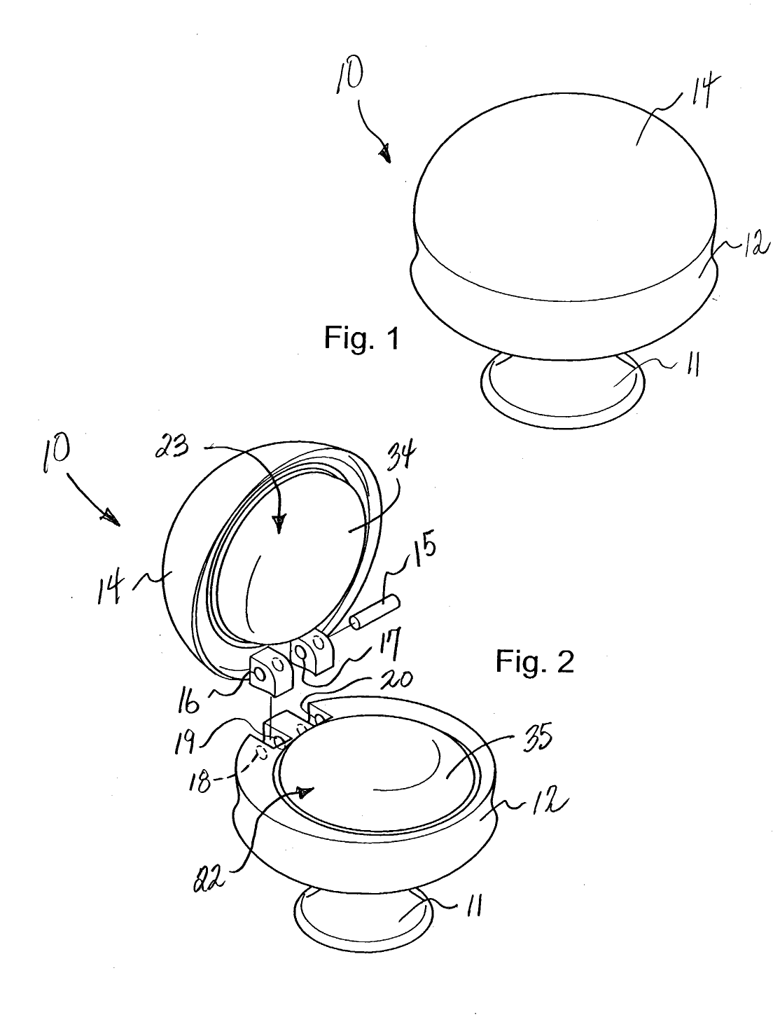

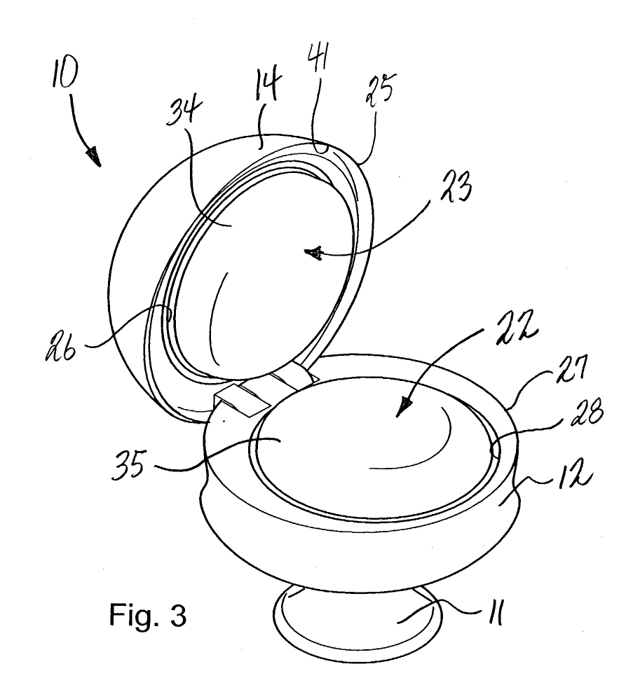

Referring now specifically to the drawings, a folding chair according to the present invention is illustrated in FIG. 1, and shown generally at reference numeral 10. The chair 10 has a base 11, seat 12 and back 14. The seat 12 and back 14 are connected together by an elongated hinge pin 15 shown in FIG. 2. The hinge pin 15 extends through aligned openings 16, 17, 18, 19, and 20 formed with the seat 12 and back 14. In the chair shown, the back 14 is design to pivot between a closed position, as in FIG. 1, and an open position, as in FIG. 3. When in the closed position, the chair 10 has a playful mushroom-like design which is particularly suited for neighborhood playgrounds, parks, and school grounds. In alternative embodiments, the chair 10 is applicable for other outdoor uses, such as stadium seating, boat chairs, lawn furniture, and patio and deck furniture. Depending on its application, the seat 12 of the chair 10 may pivot upwardly to seal against the back 14 in the closed chair position. In this case, the seat 12 and back 14 may or may not be directly mechanically linked together. At least one of the seat 12 and back 14 is separately anchored to supporting structure while the base 11 of the chair 10 is eliminated.

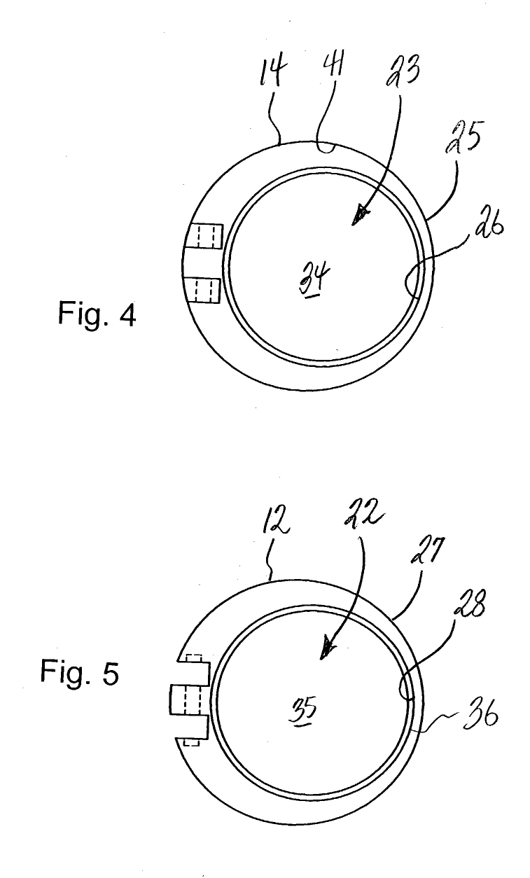

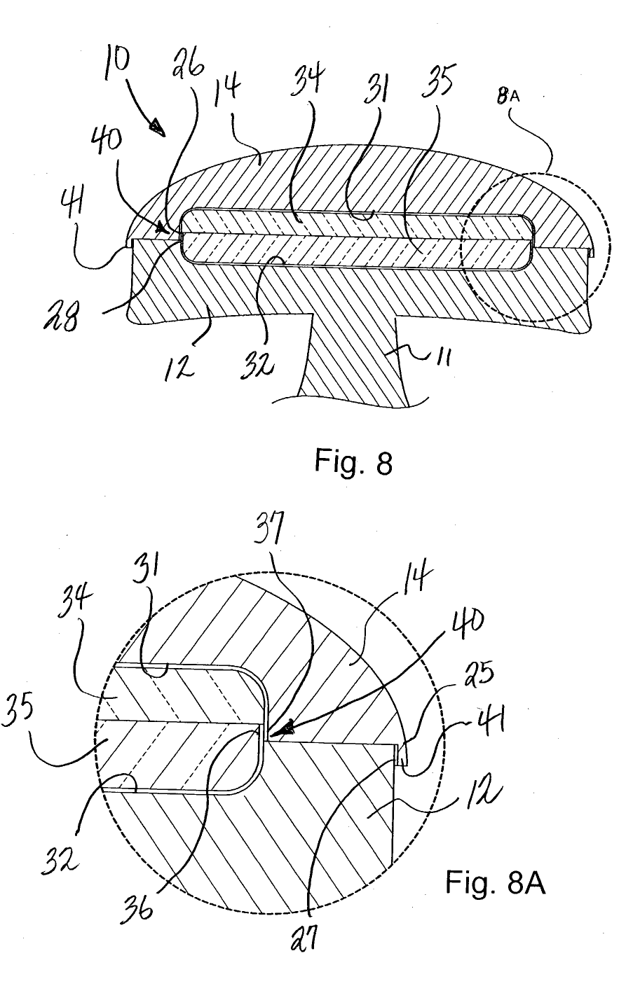

When the chair 10 is in the open position, the seat 12 and back 14 define a top sitting area 22 and back support area 23, respectively, for supporting the user in a sitting position. The back support area 23, best shown in FIGS. 3 and 4, has an outer and inner perimeter 25, 26 corresponding generally to an outer and inner perimeter 27, 28 of the top sitting area 22, shown in FIGS. 3 and 5. Respective recesses 31 and 32 (See FIG. 8) are formed within the inner perimeters 26, 28 for receiving soft foam cushions 34 and 35. The cushions 34, 35 are positioned to engage the seated user for added comfort.

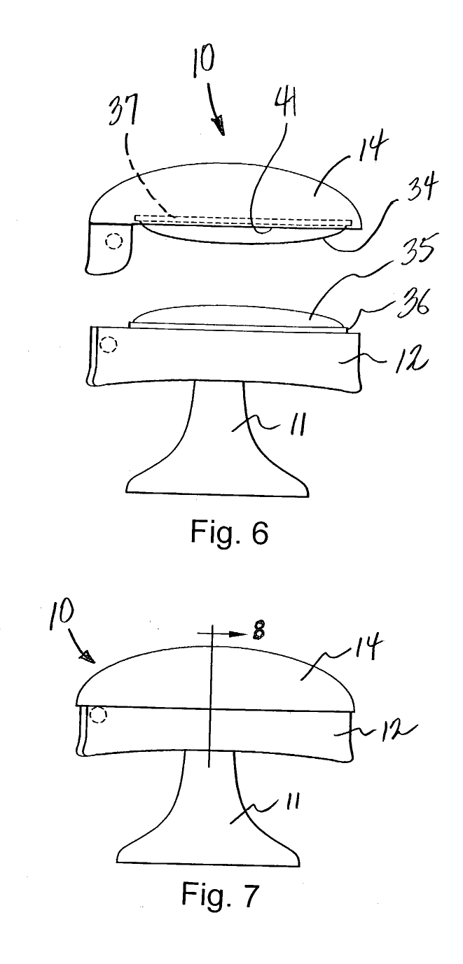

As shown in FIGS. 5 and 6, a seat rim 36 extends 360-degrees around the inner perimeter 28 of the top sitting area 22. When the chair 10 is closed, as in FIGS. 7 and 8, the rim 36 is designed to fit closely adjacent a mouth 37 of the recess 31 formed with the back 14. The foam cushions 34, 35 reside in precise overlying registration and are sufficiently compressible to allow complete engagement of the top sitting and back support areas 22, 23 in the closed chair position. The inner perimeters 26, 28 of the back 14 and seat 12 substantially align, as shown in FIG. 8, to form a common perimeter 40 which is entirely secured against entry of outside elements, such as water, dirt, sand, food crumbs, and beverage spills. The resulting seal created by the seat rim 36 is best illustrated in FIG. 8A. For additional sealing, the back 14 of the chair 10 may further include an annular outer rim 41 formed at the outside perimeter 25 which overlaps the outside perimeter 27 of the seat 12 in the closed chair position. When the chair 10 is returned to the open position, the entire top sitting and back support areas 22, 23 are clean and dry and ready for immediate use.

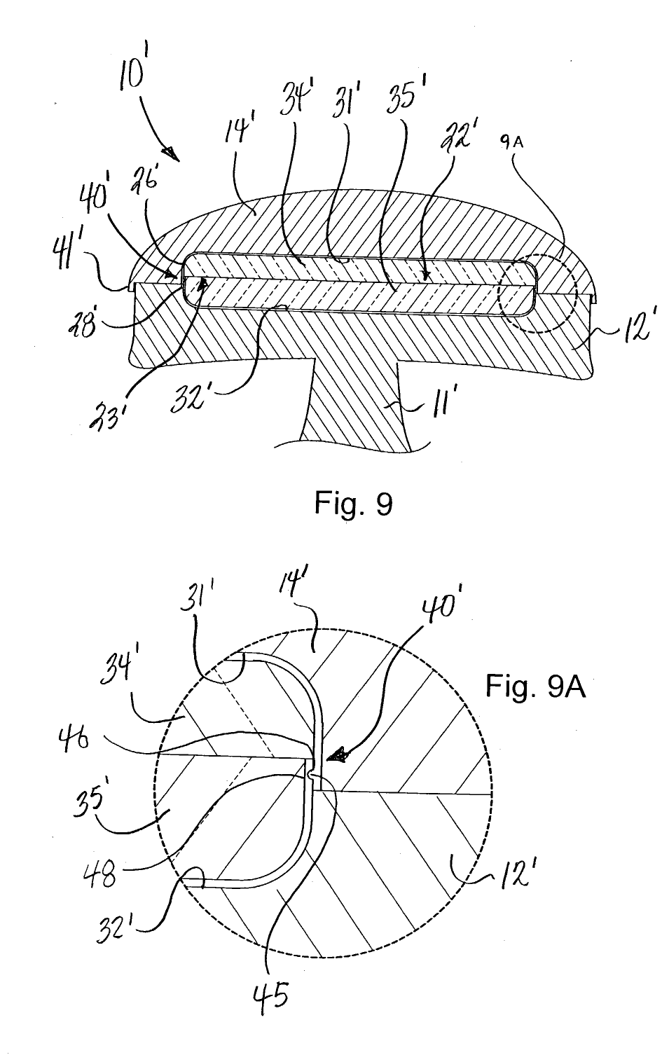

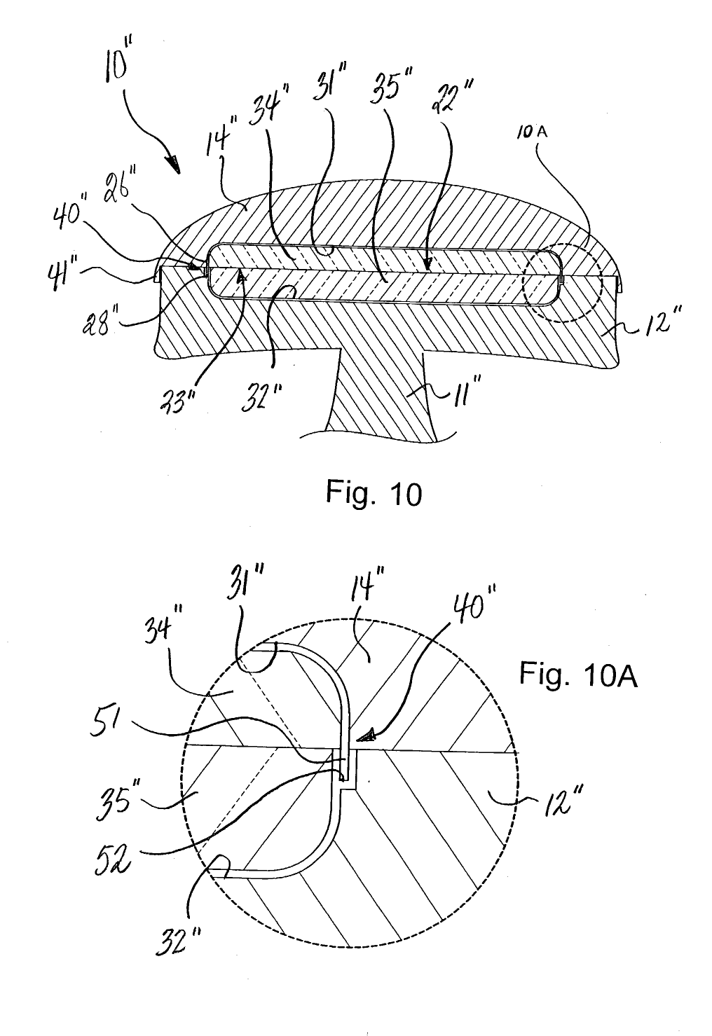

Alternative means for securing the common perimeter 40 in the closed chair position are illustrated in FIGS. 9 & 9A and 10 & 10A. Like elements shown in these drawings are indicated in prime (′) and double prime (″) notation, respectively. Referring to FIGS. 9 and 9A, the mouth 37′ of the back recess 31′ includes an annular rib 45 designed to mate with a complementary annular groove 46 formed in the rim 48 located at the inner perimeter 28′ of the top sitting area 22′. When the chair 10 is closed, the rib 45 and groove 46 cooperate to snap attach the seat 12′ and back 14′ together forming a complete seal at the common perimeter 40′. In FIGS. 10 and 10A, a back rim 51 extends 360-degrees around the inner perimeter 26″ of the back support area 23″. When the chair 10″ is closed, the back rim 51 is designed to fit inside a complementary vertical channel 52 formed at the inner perimeter 28″ of the top sitting area 22″. The rim 51 and seat channel 52 cooperate to secure the common perimeter 40″ against entry of outside elements.

In further embodiments (not shown), the common perimeter may be secured when the chair is closed by using one or more small outwardly-projecting dowel pins attached to one of the seat and back and designed to fit inside complementary holes formed with the other of the seat and back. Alternatively, one of the seat and back may have an annular or closed-end foam rubber seal, such as conventional weather stripping or an O-ring, designed to engage a surface of the other of the seat and back.

A folding chair is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

1. A folding chair, comprising:
(a) a seat defining a top sitting area adapted for supporting a user in a sitting position;
(b) a back extending outwardly from said seat in an open chair position, and defining a back support area for engaging a back of the user;
(c) a hinge connecting said seat and said back whereby at least one of said seat and back is moveable from the open chair position to a closed chair position, and in the closed chair position, the back support and sitting areas reside in overlying relation within a common perimeter; and
(d) means for securing the common perimeter against entry of outside elements such that the back support and sitting areas remain clean when said chair is returned to the open chair position.

2. A folding chair according to claim 1, wherein said means for securing the common perimeter comprises a rim formed with said back and adapted to fit closely adjacent an edge of said seat.

3. A folding chair according to claim 1, wherein said seat defines a recess adapted for receiving a seat cushion in the top sitting area.

4. A folding chair according to claim 3, wherein said back defines a recess adapted for receiving a back cushion in the back support area.

5. A folding chair according to claim 4, wherein said means for securing the common perimeter comprises an annular rim extending around the recess formed with one of said seat and back, and adapted to fit closely adjacent an annular mouth of the recess formed with the other of said seat and back.

6. A folding chair according to claim 5, wherein one of said annular rim and mouth comprises a locking rib and the other of said annular rim and mouth comprises a complementary groove, said rib and groove cooperating to snap attach the back and seat together with said chair in the closed chair position.

7. A folding chair according to claim 1, wherein said means for securing the common perimeter comprises a rim formed with one of said seat and back, and a complementary perimeter channel formed with the other of said seat and back and adapted for receiving said rim.

8. A folding chair according to claim 1, wherein said back comprises a cushion located in the back support area.

9. A folding chair according to claim 1, wherein said seat comprises a cushion located in the sitting area.

10. A folding chair, comprising:
(a) a seat defining a top sitting area adapted for supporting a user in a sitting position;
(b) a back extending outwardly from said seat in an open chair position, and defining a back support area for engaging a back of the user;
(c) means for arranging said seat and said back whereby at least one of said seat and back is moveable from the open chair position to a closed chair position, and in the closed chair position, the back support and sitting areas reside in overlying relation within a common perimeter; and
(d) means for securing the common perimeter against entry of outside elements such that the back support and sitting areas remain clean when said chair is returned to the open chair position.

11. A folding chair according to claim 10, wherein said means for securing the common perimeter comprises a rim formed with said back and adapted to fit closely adjacent an edge of said seat.

12. A folding chair according to claim 10, wherein said seat defines a recess adapted for receiving a seat cushion in the top sitting area.

13. A folding chair according to claim 12, wherein said back defines a recess adapted for receiving a back cushion in the back support area.

14. A folding chair according to claim 13, wherein said means for securing the common perimeter comprises an annular rim extending around the recess formed with one of said seat and back, and adapted to fit closely adjacent an annular mouth of the recess formed with the other of said seat and back

15. A folding chair according to claim 14, wherein one of said annular rim and mouth comprises a locking rib and the other of said annular rim and mouth comprises a complementary groove, said rib and groove cooperating to snap attach the back and seat together with said chair in the closed chair position.

16. A folding chair according to claim 10, wherein said means for securing the common perimeter comprises a rim formed with one of said seat and back, and a complementary perimeter channel formed with the other of said seat and back and adapted for receiving said rim.

17. A folding chair according to claim 10, wherein said back comprises a cushion located in the back support area.

18. A folding chair according to claim 10, wherein said seat comprises a cushion located in the top sitting area.
